(19) United States
(12) Patent Application Publication
(10) Pub. No.: US 2005/0111801 A1
(43) Pub. Date: May 26, 2005

(54) Flexible Optical Fiber Ribbon Cable, Fiber Optic Reformattor, and Method for Making Same Cable and Reformattor

(75) Inventors: John Garman, Long Beach, CA (US); Nahum Gat, Manhattan Beach, CA (US)

Correspondence Address: OPTO-KNOWLEDGE SYSTEMS, INC., 4030 SPENCER ST., SUITE 108, TORRANCE, CA, 90503, US

(73) Assignee: OPTO-KNOWLEDGE SYSTEMS, INC., Torrance, CA (US)

(21) Appl. No.: 10/707,188

(22) Filed: Nov. 25, 2003

(51) Int. Cl. G02B 6/44

(52) U.S. Cl. 385/114

(57) ABSTRACT

The inventive method and apparatus relate to fiber optic ribbon cable capable of being bent and curved through a very small bend radius. The method involves an improvement to the direct-melt ribbon-cable manufacturing process, creating ribbon cables with adhered ends, and un-adhered fiber centers. Such ribbon cable overcomes typical sideways bend radius limitations. This ribbon cable is a second aspect of the invention. A reformatter is further contemplated by this invention, wherein at least two of the inventive ribbon cables are arranged to form a rectangular array of optical fibers at one end and a linear array at the other, provding a compact optical fiber reformattor for use in space limited locations.

### BACKGROUND OF INVENTION

1. Field of the Invention

The inventive devices and method relate to optical waveguides and particularly to optical fibers. More specifically, the inventive devices and method relate to optical transmission cables with particular fiber orientations, bundle and ribbon cables, coherent bundles for imaging, and transitions between geometric shapes of waveguide cables and connectors.

2. Background

The background of the inventive devices and method involves the manufacture and use of optical fiber cables.

Well known in the art is the direct melt method of creating optical fibers. For example, see U.S. Pat. No. 4,040,807 to Midwinter et al (“Drawing Dielectric Optical Waveguides,” Aug. 09, 1977). The technique described by Midwinter and improved in the intervening decades involves multi-component glass or other materials rods combined in a molten state to form a fiber core and cladding. The “double-crucible” method is the most common process and combines the rods into a single, solid “preform,” which is then pulled into optical fiber. The concentric crucibles used allow the core to be surrounded by the cladding directly. The preform is fed into a drawing furnace that softens the end to its melting point. The softened preform is pulled into a fiber that is then pulled onto a drum that rolls the fiber into a spool. The typical materials used in optical fiber cores include silica glass, chalcogenide, other glass materials, poly and single element crystals, assorted plastics, or various other transmissive materials.

To create optical fiber ribbon cables, the successive loops of fiber pulled onto the drum can be stopped or spaced once a desired number of loops have been reached. A layer of adhesive, possibly including RTV, epoxy, or a myriad of other substances, is applied to the loops of fiber coating the drum. The adhesive adds strength to the fibers and gives them a cohesive structure, so that when they are cut on the drum, they form ribbon cables made of as many strands as there were loops on the drum before the stop or terminal spacing. The ribbon cable is as long as the circumference of the drum.

Also well known in the art are the routing limitations of optical fibers. When routing optical fibers, the fibers can be bent and curved to some minimum bend radius. Beyond the minimum bend radius (i.e., with tighter bends) the optical fiber fractures, cracks, or otherwise reduces or loses its light transmission capability. Although naked (or single) optical fibers have limited minimum bend radii, the limiting factor is often related to the mechanics of creating optical fiber ribbons or bundles.

Typically, ribbon cables have minimum bend radii greater than half an inch when bending the cable out of its plane, and far greater minimum bend radii when bending the ribbon “sideways,” within its plane. In a sideways bend, the outside fibers must not only bend, but must also elongate significantly, to accommodate a bend in the cable. Similarly, the fibers on the inside of the sideways bend must compress to accommodate the bend. Brittle substances, such as glasses, crystals, and plastics cannot compress or elongate significantly without being damaged. Therefore, typically in the art, any significant sideways bend may snap the optical fibers, so cables must be routed in such a way that avoids tight bends. Such avoidance may be impossible when cables need to follow tight mechanical contours.

Additionally, the use of optical fibers in imaging systems is well known in the art. U.S. Pat. No. 6,175,678 to Sanghera, et al, describes using chalcogenide fibers in an infrared imaging system. In such an imaging system, a lens may focus an image onto a bundle of optical fibers (for example, a sixteen by sixteen square array of fibers). The fibers, maintaining such a sixteen by sixteen bundle, can carry the image to a remotely located sixteen by sixteen pixel imaging-sensor. The fibers must be organized so that the top left fiber at the image-receiving side remains in position to project the image to the top left corner of the sensor, and likewise for each of the other fibers in the cable.

Fiber optic reformattors are also well known in the art. U.S. Pat. No. 4,678,332 to Rock et al, describes the use of a fiber optic reformattor that is, a coherent bundle of fiber optics at one end, converted to a single row of fiber optics at the other end. Rock takes an image, focused onto a two dimensional array (square, rectangular, etc) of fibers, and converts the rows or columns of the two-dimensional array into at least one linear array. That is, for example, an m by n array of fibers is converted to a single linear array, m times n fibers wide. This allows the entire two-dimensional image to be passed to the entrance slit a spectrometer.

In order to reformat a bundle of optical fibers to a linear array, the fibers must be spread over a wide area. A square bundle of fibers sixteen fibers wide, for example, must be spread to two hundred fifty six fibers wide. Such an arrangement, made out of single fibers, is very difficult to implement. Manipulating two to one hundred micron fibers to arrange them in a bundle at one end and then a cohesive linear array at the other end, especially over a short length, is impracticable. However, attempting to create such a reformattor with optical fiber ribbon cables, where the fibers are already organized in a linear manner, is also quite difficult, as doing so requires a sideways bend of the cables that calls into consideration the minimum bend radius of the cables. Because of the limited bend radius in the plane of the cable, in order to make such a reformattor conversion, a relatively long length of transition cable is needed. Such a configuration may not be appropriate in some applications, including in compact spectrometers, where reformatting may need to be completed in a very small amount of space. If a geometric change were needed within a limited size apparatus, long optical fiber cables would require complex routing that may not be possible.

This problem is exacerbated in cases where less flexible optical fibers are used. For example, certain chalcogenide optical fibers are too brittle to use as single fibers and are too inflexible to use in ribbon cables, in terms of sideways bends. This is especially a limitation in the art in the case of infrared spectrometers, as flexible, durable visible light optical fibers cannot efficiently transmit infrared light, so the more physically restrictive chalcogenide fibers are often employed. These fibers are flexible to some small degree, when alone, but too brittle to be manipulated, and too sensitive to bending in cable form.

Therefore, there is a need in the art for a way to complete geometric changes to optical fiber cabling that allows dramatically reduced bend radii from those of typical bundle or ribbon cables. There is a need in the art for a method to convert a linear array of optical fibers into a square bundle of fibers, while providing a mapped organization. There is a further need in the art for a ribbon cable capable of being routed as necessary for such reformatting, as well as a device to complete such reformatting with such ribbon cables.

### SUMMARY OF INVENTION

Accordingly, the first aspect of the invention comprises a method of manufacture for a fiber optic ribbon cable capable of being bent and curved through a very small bend radius. The method involves a modification to the direct-melt ribbon-cable manufacturing process. Once a desired number of wraps of the drum have been completed, the application of the adhesive is modified so that the adhesive is placed on less than the entire circumference of the drum, leaving a portion of the circumference un-adhered. The ribbon cable is then cut through the adhesive-covered portion (though not necessarily in the middle of the covered portion), creating the inventive ribbon with adhered ends, and un-adhered fiber centers. Such a ribbon cable solves the problem described above with ribbon cable sideways bend radius limitations. The cable can bend sideways and the un-adhered fiber centers can move to allow radii approaching the limit of the fiber, far smaller than the sideways bend limit of a typical ribbon cable.

The inventive ribbon cable created by the inventive method is a second aspect of the invention. It is an object of this aspect of the invention to provide a cable useful where tight bend radii are necessary, especially in cases where using the optical fibers completely un-adhered would be impractical or impossible, due to difficulty in manipulating small, short fibers, or due to their fragile nature.

A third object of the present invention is to provide a reformattor comprised of at least two of the inventive ribbon cables. By placing two or more of the inventive cables on top of one another to form a rectangular array of optical fibers and aligning the opposite ends of the cables in a linear manner, the inventive reformattor provides a compact optical fiber reformattor for use in space limited locations, including in infrared spectrometers.

### BRIEF DESCRIPTION OF DRAWINGS

The accompanying views of the drawings are incorporated in, and constitute a part of, this specification and illustrate one or more exemplary non-limiting embodiments of the invention, which, together with the description, serves to explain the principles of the invention. In the drawings:

FIG. 1 is a schematic diagram of a typical direct melt optical fiber apparatus;

FIG. 2 shows a view of the inventive method;

FIG. 3 is a schematic view of the direct melt drum diagramming the inventive changes to the typical procedure;

FIG. 4 is a schematic view of an embodiment of the inventive ribbon cable; and

FIG. 5 is a schematic view of an embodiment of the inventive reformattor.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives, and uses of the invention, including what are presently believed to be the best modes of carrying out the invention.

In this regard, the invention is illustrated in the several figures and is of sufficient complexity that the many parts, interrelationships, process steps, and sub-combinations thereof simply cannot be fully illustrated in a single patent-type drawing or table. For clarity and conciseness, several of the drawings show particular elements in schematic and omit other parts or steps that are not essential in that drawing to a description of a particular feature, aspect, or principle of the invention being disclosed.

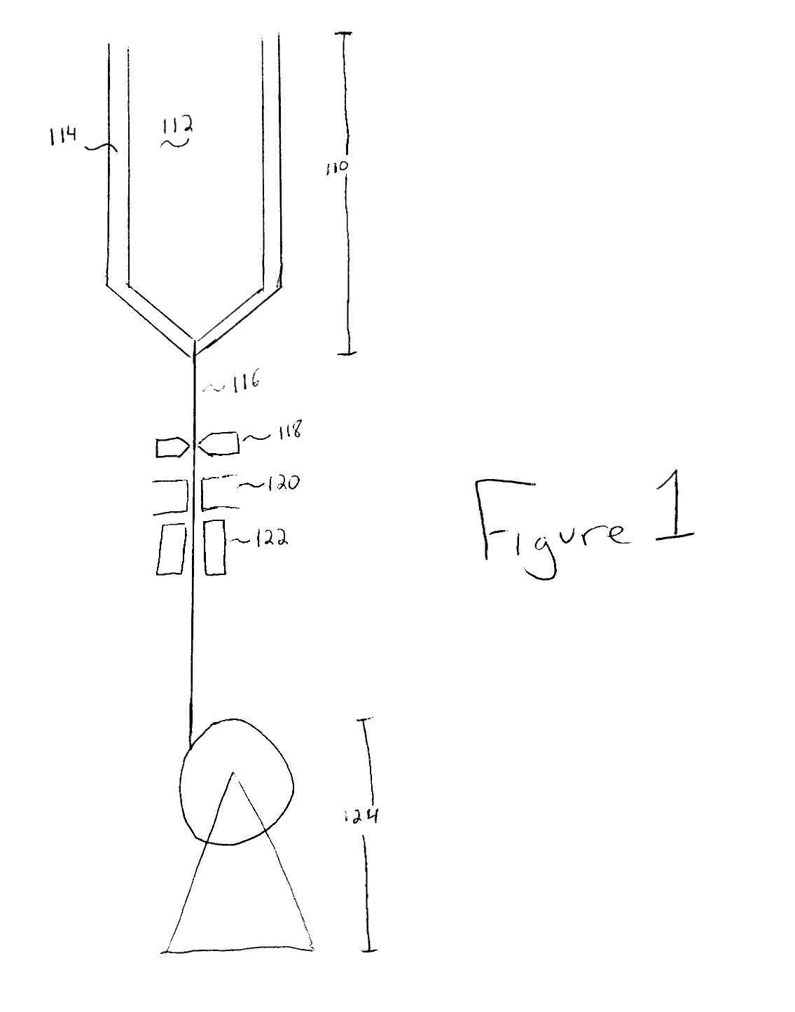

FIG. 1 is a schematic diagram of a typical direct melt optical fiber apparatus. In the figure, the feed rod apparatus (110) is a double crucible for illustrative purposes only. Any direct melt feed system is contemplated. In the double crucible system (110), the center crucible (112) contains the core feed material, which is typically glass, crystal, or plastic, including silica for typical visible light optical fibers or chalcogenides for typical infrared applications. The outer crucible (114) contains the cladding material that provides the change in refraction index to the optical fiber as well as other properties (such as protection). The optical fiber (116) is pulled out of the feed rod apparatus (110) and passes through a several additional process steps, which can vary by specific direct melt technique. In FIG. 1, the included components are a thickness monitor (118), a final coating applicator (120), and a coating-curing oven (122). The optical fiber (116) is then pulled onto the take-up drum (124) where it spools onto the drum (124). To make a ribbon cable consisting of ten optical fibers, the optical fiber (116) is pulled onto the drum and wrapped around the drum (124) ten times. The drum (124) is indexed or translated one fiber optic diameter between each wrap. After the tenth wrap, the drum (124) moves slightly further to leave a space between the tenth and eleventh wrap. The process then optionally starts again to make a second group of ten wraps. Eventually, when the drum is wrapped as desired, the drum is coated with adhesive. When the adhesive is sufficiently strong to hold the optical fibers together, the groups of fibers are cut from one another and sliced in such a way to open the fibers as ribbon cables whose length is the circumference of the drum (124).

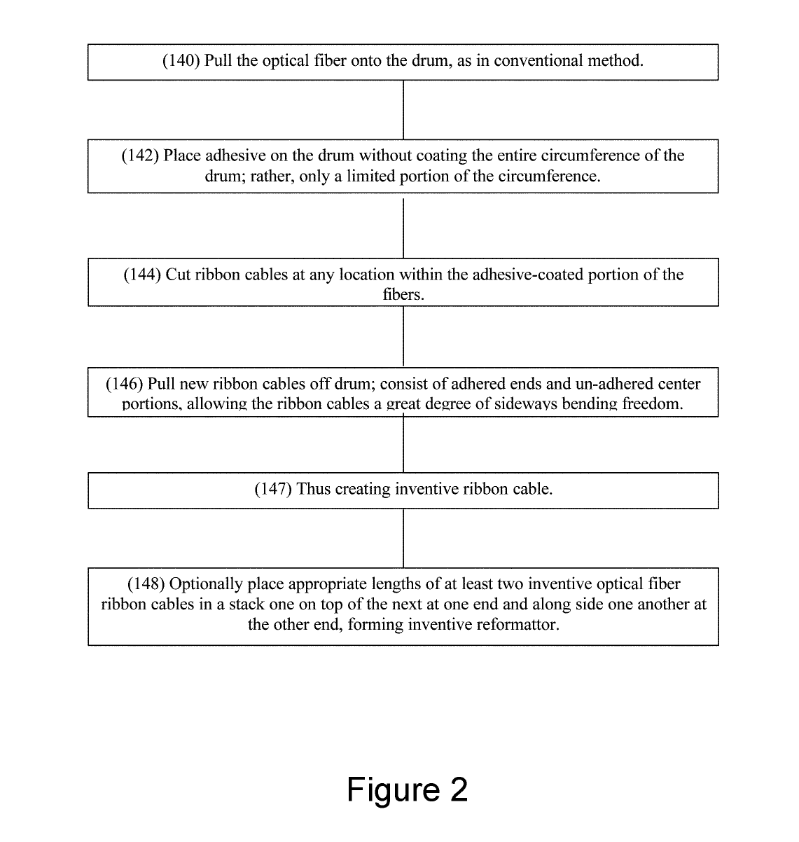

The inventive method, shown in FIG. 2, begins with a typical direct melt process as shown in FIG. 1. The inventive method begins (140) with pulling the optical fiber onto the drum. The first inventive step (142) is to place the adhesive on the drum without coating the entire circumference of the drum; rather, only a limited portion of the circumference receives adhesive. The second inventive step (144) comprises the ribbon cables being cut at any location within the adhesive-coated portion of the fibers. When pulled off the drum (146), the new ribbon cables consist of adhered ends and un-adhered center portions, allowing the ribbon cables a greater degree of sideways bending freedom. The inventive method either ends here, with an inventive ribbon (147) or the optional last inventive step (148) then comprises placing appropriate lengths of at least two inventive optical fiber ribbon cables in a stack one on top of the next at one end and along side one another at the other end. The last step thus forms a rectangular array of optical fibers at one end and a linear array of optical fibers at the other end and provides a reformattor for a two dimensional image to be projected in a “one-dimensional” one fiber wide array. The linear array can then provide optical signal to the entrance slit of a spectrometer.

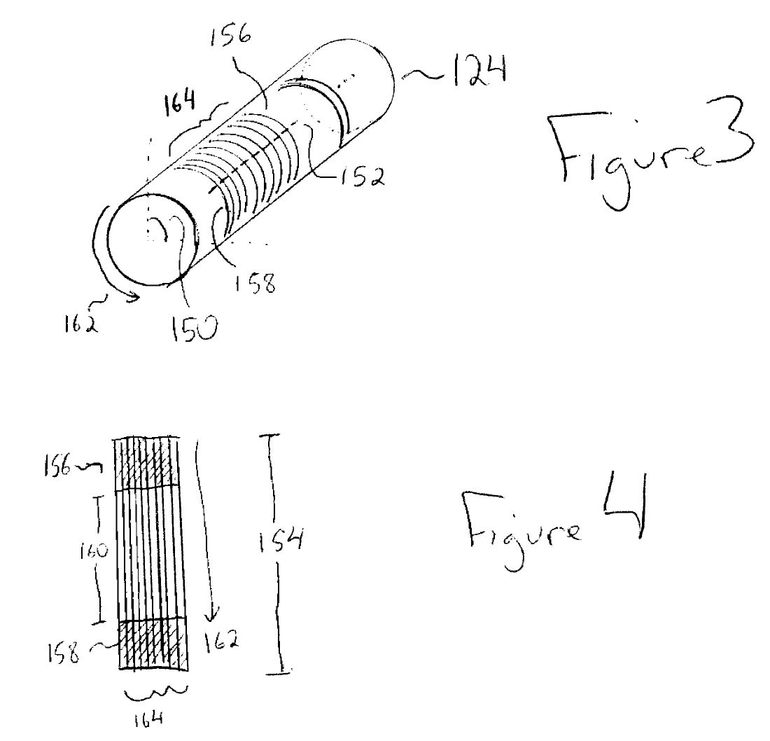

The inventive method of FIG. 2 is shown in schematic form in FIG. 3. The drum (124) is shown with an exemplary adhesive inclusive angle (150) over which the adhesive is applied. In this example, the number of wraps of the drum before the “break” is ten (shown as 164). The dashed line (152) represents the location of the cut used to form the inventive ribbon cables (cables shown in FIG. 4) with ends (156, 158). The drum's circumference (162) will determine the length of the inventive ribbon cable. FIG. 4 shows a schematic view of the inventive ribbon cable (154), which has two coated ends (156, 158) and a non-coated center section (160) allowing tight bend radii for such cables. The length (162) of the inventive ribbon cable (154) is equal to the circumference of the drum shown in FIG. 3. The number of optical fibers (ten, shown at 164) in the ribbon cable is determined by the number of wraps of the drum completed before a space was inserted in the wrapping of the drum.

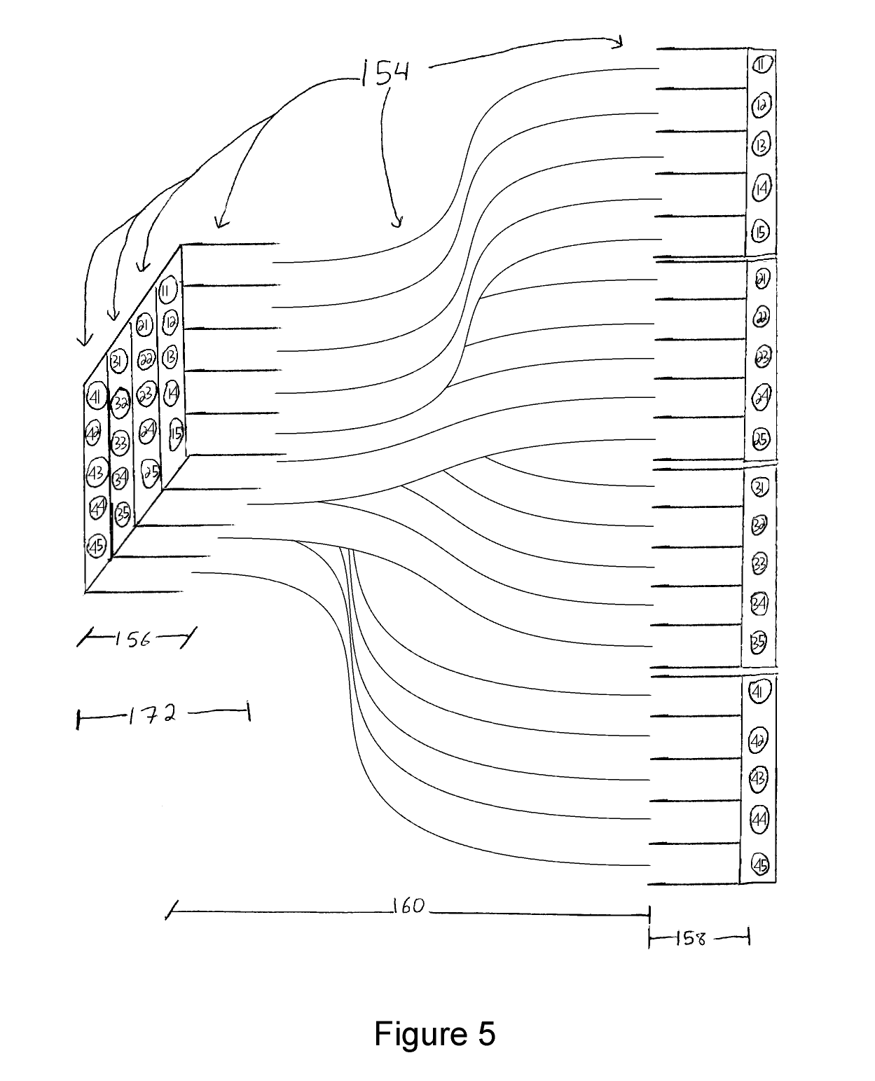

Finally, FIG. 5 is a schematic view of an embodiment of the inventive reformattor. Several inventive ribbon cables (154) are piled one on top of the other to form a rectangular array (172) of optical fibers. In this example, the array is a five by four array. In other words, the ribbon cables contain five optical fibers each and there are four of them stacked together. For clarity, the optical fibers are numbered 11 to 15 for row one, 21 to 25 for row two, and so on to 41 to 45 for row five. At the other end of the cables, the ends are lined up in a linear array, with the fibers maintaining their same numbering structure. This organized arrangement allows the reformattor to put the source light into the entrance slit of a spectrometer, for example. The fibers are shown with inventive adhered ends (156, 158) and unadhered flexible centers (160).

The method presented herewith represents the current best mode of economically producing the devices of the present invention in relatively low volumes. However, those familiar with the art will see other methods of created the inventive devices, and such methods are contemplated. For example, to reduce packaging size and transmission attenuation (at the possible cost of aperture distortion), the inventive reformattor could be formed with the rectangular array side of the reformattor being fused to form a more closely packed array. This method would involve either capturing loose fiber ends or using the method of the inventive patent and cutting the adhered ends off and fusing the rectangular array side of the reformattor. Also contemplated is using acid dissolving adhesive and/or cladding to allow the reformattor rectangular array to be fused even when using the inventive cables and reformattor.

Moreover, it is contemplated to test optical fiber devices made in accordance with the present inventive method to determine whether there is perfect fiber alignment at each end of the inventive cable or reformattor. Any incongruence with the expected alignment can be accounted for: for example, in an imaging system, by computer means, switching pixel information.

Industrial Applicability

It is clear that the flexible optical fiber ribbon cable, fiber optic reformattor, and manufacturing method of the present invention will have wide industrial applicability wherever fiber optic ribbon cables are used in small confines where flexible ribbon cables are necessary or desired. The reformattor of the present invention will have great applicability in many slit-spectroscopy applications. The inventive devices and method will further have great applicability in any circumstance where image reformatting for infrared applications are desired, or where space, weight, or cost are important factors.

1. In a direct melt method for manufacturing optical fiber ribbon cables, the improvement comprising,
a. replacing the step of adhesively coating the entire circumference of the drum on which there are spooled optical fibers with coating only a limited portion of the circumference of said drum;
b. cutting said fibrs at any location within said adhesive-coated portion of said fibers; and
c. removing the ribbon cables from said drum thus creating said ribbon cable with distal and proximal adhesively coated ends and medial uncoated ribbon cable:

2. An improved method as in claim 1 wherein said optical fibers are comprised of one of glass, crystal, and plastic optically transmissive materials.

3. An improved method as in claim 1 wherein said optical fibers are selected to transmit infrared radiation.

4. A flexible optical fiber ribbon cable made by the method of claim 1.

5. An optical fiber ribbon cable as in claim 4 wherein said optical fibers are comprised of one of glass, crystal, and plastic optically transmissive materials.

6. An optical fiber ribbon cable as in claim 4 wherein said optical fibers are selected to transmit infrared radiation.

7. A flexible optical fiber ribbon cable comprising at least two optical fibers having proximal and distal ends held together by adhesive coating at said eproximal and distal ends and having at least some portion of the fibers between said ends remaining uncoated.

8. An optical fiber ribbon cable as in claim 7 wherein said optical fibers are comprised of one of glass, crystal, and plastic optically transmissive materials.

9. An optical fiber ribbon cable as in claim 7 wherein said optical fibers are selected to transmit infrared radiation.

10. A fiber optic reformattor comprising at least two flexible optical fiber ribbon cables comprising distal and proximal ends, said ends being arranged so that at said distal end, said ribbon cables are aligned from end to end, forming a single linear array of optical fiber ends, and at said proximal end, said ribbon cables are aligned on top of one another forming a rectangular array of optical fiber ends.

11. A fiber optic reformattor comprising at least two flexible optical fiber ribbon cables made by the method of claim 1 comprising distal and proximal ends, said ends being arranged so that at said distal end, said ribbon cables are aligned from end to end, forming a single linear array of optical fiber ends, and at said proximal end, said ribbon cables are aligned on top of one another forming a rectangular array of optical fiber ends.

12. A fiber optic reformattor comprising at least two flexible optical fiber ribbon cables of the type in claim 4 comprising distal and proximal ends, said ends being arranged so that at said distal end, said ribbon cables are aligned from end to end, forming a single linear array of optical fiber ends, and at said proximal end, said ribbon cables are aligned on top of one another forming a rectangular array of optical fiber ends.

13. A fiber optic reformattor comprising at least two flexible optical fiber ribbon cables cof the type in claim 7 comprising distal and proximal ends, said ends being arranged so that at said distal end, said ribbon cables are aligned from end to end, forming a single linear array of optical fiber ends, and at said proximal end, said ribbon cables are aligned on top of one another forming a rectangular array of optical fiber ends.
